(19) United States
(12) Patent Application Publication
(10) Pub. No.: US 2005/0205389 A1
(43) Pub. Date: Sep. 22, 2005

(54) Coin conditioning device and method, and a coin processing apparatus comprising a coin conditioning device

(76) Inventor: Jerry Karlsson, Lund (SE)

Correspondence Address: WOMBLE CARLYLE SANDRIDGE & RICE, PLLC, P.O. BOX 7037, ATLANTA, GA, 30357-0037, US

(21) Appl. No.: 11/085,659

(22) Filed: Mar. 21, 2005

Related U.S. Application Data
(63) Continuation of application No. PCT/SE03/01475, filed on Sep. 23, 2003.
(60) Provisional application No. 60/413,039, filed on Sep. 24, 2002.

(30) Foreign Application Priority Data
Sep. 24, 2002 (SE) 0202819-9

(51) Int. Cl. G07D 5/08

(52) U.S. Cl. 194/317

(57) ABSTRACT

A coin conditioning device for separating non-coin matter from a plurality of coins comprises a belt conveyor having a perforated conveyor belt and a belt agitator, which is arranged for agitating the conveyor belt while said plurality of coins and said non-coin matter are being conveyed on said conveyor belt. The coin conditioning device may be provided in a coin processing apparatus. A method for conditioning a plurality of coins is also disclosed.

### CROSS-REFERENCE TO RELATED APPLICATIONS

This application is a continuation of international application no. PCT/SE2003/001475, filed on Sep. 23, 2003; which application claims the benefit of provisional application No. 60/413,039, filed Sep. 24, 2002, and Swedish application no. 0202819-9, filed Sep. 24, 2002.

### INCORPORATION BY REFERENCE

The specifications of PCT/SE2003/001475, filed on Sep. 23, 2003; 60/413,039, filed Sep. 24, 2002, and Swedish application no. 0202819-9, filed Sep. 24, 2002 are incorporated herein in their entirety, by this reference.

### TECHNICAL FIELD

The present invention relates to a coin conditioning device and method for use in a coin processing apparatus.

### BACKGROUND ART

Coin processing apparatuses are commonly found in places where there is a need for sorting and/or counting large quantities of coins. One common type of coin processing apparatus may comprise an input tray and a coin lifting device, also known as a “hopper”. The input tray is arranged for receiving a mass of coins that are to be sorted, and the coin lifting device is arranged for establishing an order, e.g. a sequential order, of the coins, such that they may be sorted in e.g. a coin discriminating device. After, or while, being sorted, the coins may be verified by a coin verification device to ascertain that they have the properties of valid coins.

Typically, the coin processing device also comprises a coin counting device for counting the coins and providing an output representing a value of the processed coins.

The components of the coin processing apparatus, such as the coin lifting device, the coin discriminating device, the coin verification device and the coin counting device, may be sensitive to non-coin matter, such as paper clips, dust, fluff, staples, buttons and other items that may accompany a mass of coins that have resided in e.g. a person's pocket or in a piggy bank. Since such non-coin matter may disturb, or even damage, the function of the components of the coin processing apparatus, it is desirable to have the non-coin matter removed prior to the mass of coin being processed by the coin processing apparatus. It should be noted that it is not an issue here to remove non-coin matter having essentially the shape of coins, such as tokens or non-valid (e.g. foreign) coins. Such non-coin matter is generally discriminated in a later step in the coin processing apparatus.

Various types of coin conditioning devices for conditioning or cleaning a mass of coins, prior to it being processed by the coin processing device, are known.

U.S. Pat. No. 5,482,916 discloses a coin conditioning device comprising a rotatable container, having perforated walls and vanes for causing the mass of coins to be conveyed forward through the container. The described coin conditioning device works like a screw tube conveyor, causing the mass of coins to tumble inside the conveyor, while non-coin matter is allowed to fall out of the container through the perforations in the walls.

WO 96/30877 discloses a similar, rotatable coin conditioning device, wherein the vanes are replaced by a screw conveyor that is arranged inside the perforated container.

It is desirable to provide a coin conditioning device, which is fast and which provides an even flow of coins to the components downstream of the coin conditioning device.

### SUMMARY OF THE INVENTION

It is thus an objective of the present invention to provide a coin conditioning device which is fast and which provides an even flow of coins to the components downstream of the coin conditioning device.

The above-stated object is wholly or partly achieved by a device, a coin processing apparatus and a method according to the independent claims. Embodiments of the invention are set forth in the dependent claims, in the following description and in the appended drawings.

Thus, according to a first aspect of the invention, there is provided a coin conditioning device for separating non-coin matter from a plurality of coins. The coin conditioning device comprises a belt conveyor having a perforated conveyor belt, and a belt agitator, which is arranged for agitating the conveyor belt while said plurality of coins and said non-coin matter are being conveyed on said conveyor belt. In an embodiment of the coin conditioning device, the conveyor belt has a section that is upwardly inclined in the conveyor belt's principal direction of movement.

According to a second aspect of the invention, there is provided a coin processing apparatus for processing a plurality of coins, the coin processing apparatus comprising the coin conditioning device described above.

According to a third aspect of the invention, there is provided a method for conditioning a plurality of coins by separating non-coin matter from said plurality of coins. The method comprises conveying said plurality of coins, including said non-coin matter, on a belt conveyor having a perforated conveyor belt, while causing said conveyor belt to agitate, so as to cause at least some of said non-coin matter to fall through said perforated belt. In an embodiment of the method, the plurality of coins is conveyed on a perforated conveyor belt, which is upwardly inclined in its principal direction of movement.

A belt conveyor generally consists of an “endless” belt, which is arranged around two spaced-apart pulleys. The endless belt may be either a true endless belt or an elongate band, whose ends have been joined together, such as to form the “endless” belt.

The perforated conveyor belt according to the invention is a belt having a pattern of perforations or through holes, all of which being sufficiently small so as to prevent a coin of the smallest size that is to be processed from passing through them. The exact shape of the perforations may vary, as long as the smallest coins that are to be processed are not able to pass through them.

The conveyor belt's principal direction of movement is the direction in which the load side (typically the upper side) of the belt is moving during normal operation. Furthermore, the conveyor belt being inclined means that one of its ends is situated at a higher vertical level than the other end.

The conveyor belt is caused to agitate means that a sufficient agitation, such a vibration or shaking, is provided for disturbing the load of coins carried on the conveyor belt. The amplitude and direction of the agitation may be varied according to what is appropriate for the specific embodiment.

A coin processing apparatus is an apparatus capable of receiving a plurality of coins and performing a desired operation upon the coins, including, but not limited to, coin sorting, coin counting, coin discrimination and coin validation.

### BRIEF DESCRIPTION OF THE DRAWINGS

Embodiments of the invention will now be described with reference to the appended, exemplifying drawings.

FIG. 1 is a perspective view of a coin processing apparatus, housing closed.

FIG. 2 is a perspective view of the coin processing apparatus of FIG. 1, housing open, thereby revealing a coin conditioning device comprised in the coin processing apparatus.

FIG. 3 is a perspective view of a first embodiment of the coin conditioning device of FIG. 2.

FIG. 4 is a perspective view of a second embodiment of a coin conditioning device.

FIG. 5 is a cross sectional view of the coin conditioning device of FIG. 4.

FIGS. 6a and 6b are top views of different perforation patterns for the conveyor belt of the coin conditioning device of FIG. 2.

FIGS. 7a-f are perspective views of alternative pulley designs.

FIG. 8a is a top view of an embodiment of a conveyor belt.

FIG. 8b is a cross sectional view of another embodiment of a conveyor belt.

FIG. 9 is a perspective view of one of the pulleys used in the embodiments shown in FIGS. 3-5.

FIG. 10 is a perspective view of a belt agitator used in the embodiment of FIG. 3.

### DESCRIPTION OF EMBODIMENTS OF THE INVENTION

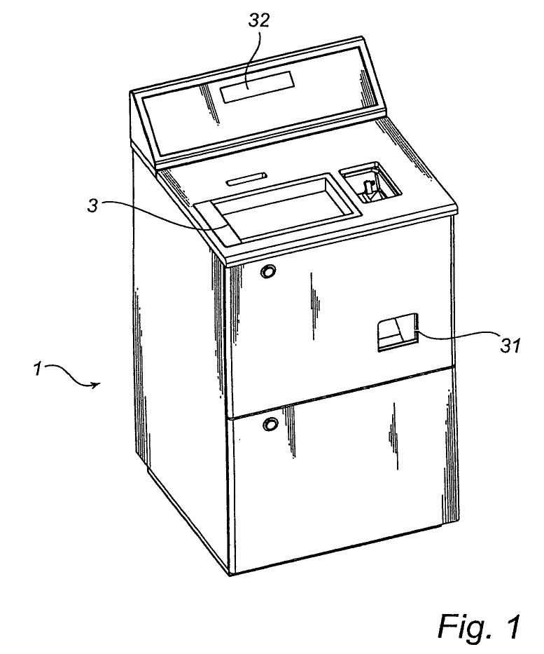

FIG. 1 is a perspective view of a coin processing apparatus 1, its housing being closed, as is the case during normal operation of the apparatus. The coin processing apparatus 1 comprises an input tray 3, which in this embodiment is arranged as a recess in a top surface of the coin processing apparatus. The input tray 3 may be tilted, either by a user or automatically when the apparatus is activated, in order to feed a plurality of coins (not shown) provided by the user into the coin processing apparatus 1. Alternatively, the input tray 3 may comprise an inclined surface, which causes the coins to be fed into the coin processing apparatus 1, e.g. in response to a gate (not shown) being opened. FIG. 1 also shows a reject box 31 for rejected coins and a display panel 32 for communication with a user.

From the input tray 3, the plurality of coins is typically fed to a coin conditioning device 2.

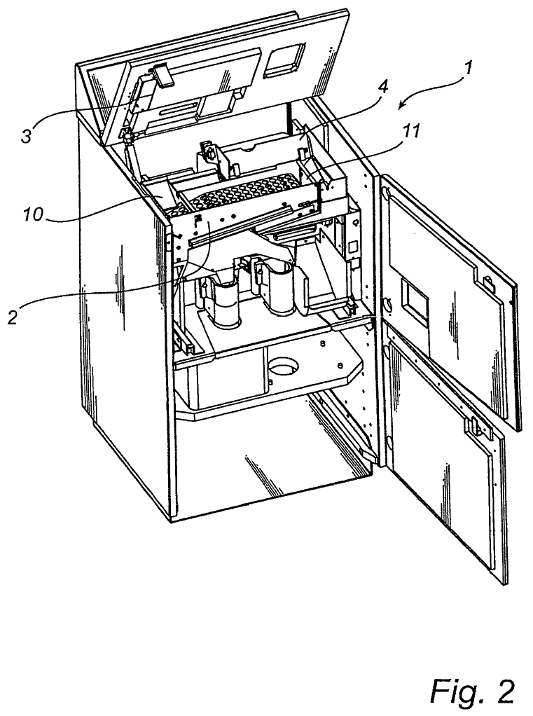

FIG. 2 is a perspective view of the coin processing apparatus 1 of FIG. 1, its housing being open, so that its interior is uncovered. FIG. 2 shows the coin conditioning device 2, having an input end 10, which is arranged so as to correspond to receive the plurality of coins from the input tray 3 (which in FIG. 2 is shown from below). At an output end 11 of the coin conditioning device 2, a coin lifting device 4, also known as a “hopper”, is arranged, so as to receive coins that have been conveyed through the coin conditioning device 2 and thus should be in condition for being sorted. The coin lifting device 4 is not essential to the invention and does not need to be described in detail herein. The coin processing apparatus 1 typically comprises electronic control equipment (not shown) for monitoring and controlling the function of the apparatus 1, including the coin conditioning device.

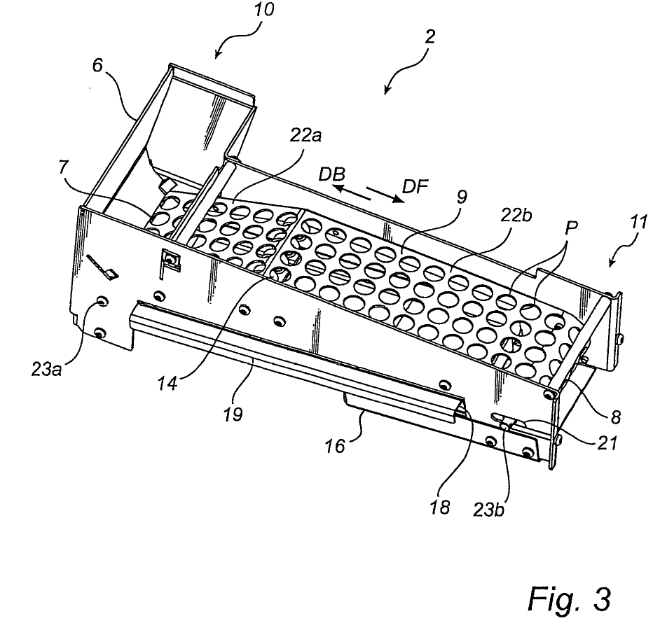

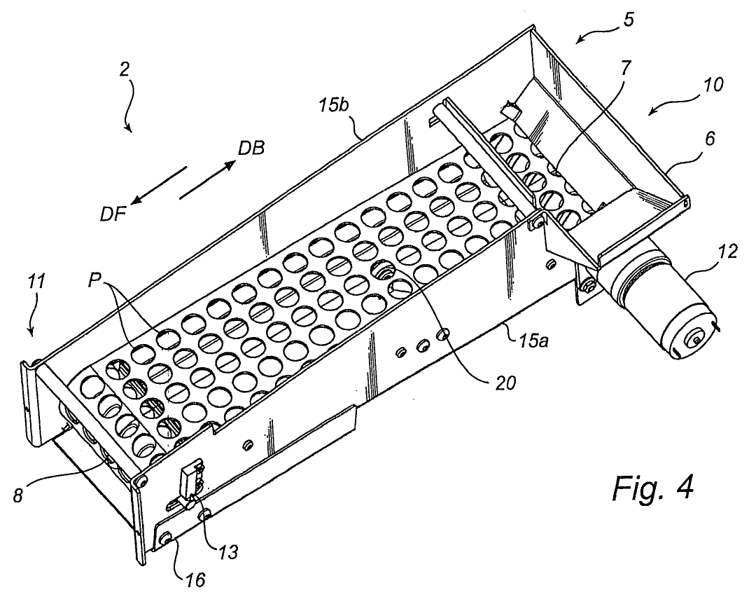

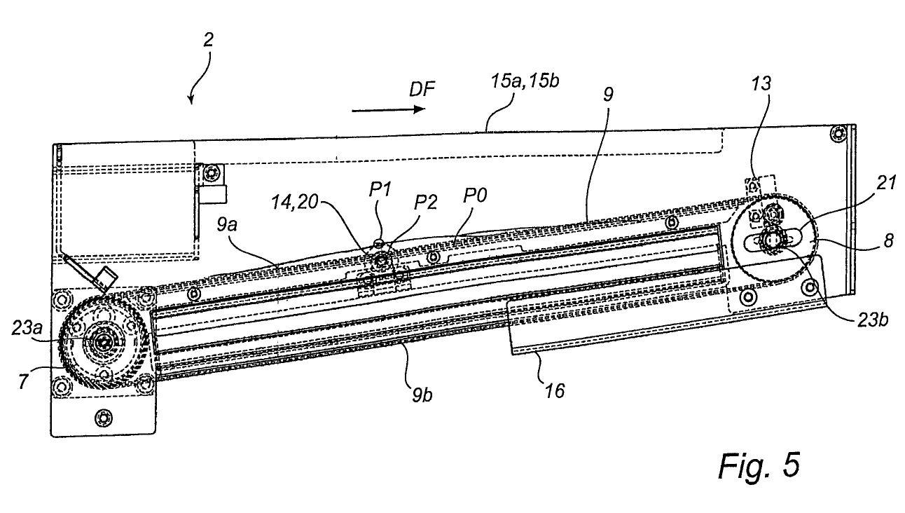

The coin conditioning device 2 will now be described in closer detail with reference to FIGS. 3-5. FIG. 3 is a perspective view of a first embodiment of the coin conditioning device 2 of FIG. 2. FIG. 4 is a perspective view of a second embodiment of a coin conditioning device 2, which differs slightly from that of FIG. 3. FIG. 5 is a cross-sectional view of the coin conditioning device 2 of FIG. 4.

The basic idea of the coin conditioning device 2 is that a plurality of coins are conveyed on a perforated conveyor belt 9, while the belt 9 is agitated, thus causing any non-coin matter, which is small enough to pass through the perforations, to be separated from the coins and to fall down into a dust collection tray 18.

The coin conditioning device 2 comprises first and second side walls 15a, 15b, which are arranged to form an elongate frame 5 for the coin conditioning device 2. The frame 5 may, at the input end 10 of the device 2, comprise a receiving funnel 6, or a similar device, for receiving the plurality of coins (not shown), which are fed from the input tray 3.

At each end of the frame 5, a first 7 and a second 8 pulley are arranged, respectively. In the embodiment of FIG. 3, the pulleys 7, 8 may comprise a plurality of discs, which are laterally spaced and arranged to rotate around a common axis. At least one of the pulleys 7, 8 may be displaceable, so as to facilitate assembly/disassembly of the conveyor belt and so as to allow adjustment of the distance between the pulleys 7, 8. For example, the displaceability may be implemented by arranging an axis 23a, 23b of a pulley 7, 8 in a groove 21 in the side walls 15a, 15b, said groove having an extension in a direction towards the other pulley 8, 7. The axes 23a, 23b may be fixed relative to the frame 5 at a desired position in said groove in any known fashion.

A perforated conveyor belt 9 is arranged around the pulleys 7, 8. The conveyor belt 9 thus has an upper portion 9a, which is the upper part of the conveyor belt, i.e. the load bearing part. The surface of this upper portion 9a is arranged to move in a direction which is defined as the conveyor belt's principal direction of movement (DF). Furthermore, the conveyor belt has a lower portion 9b, which is located underneath the upper portion 9a and which consequently moves in the opposite direction (DB).

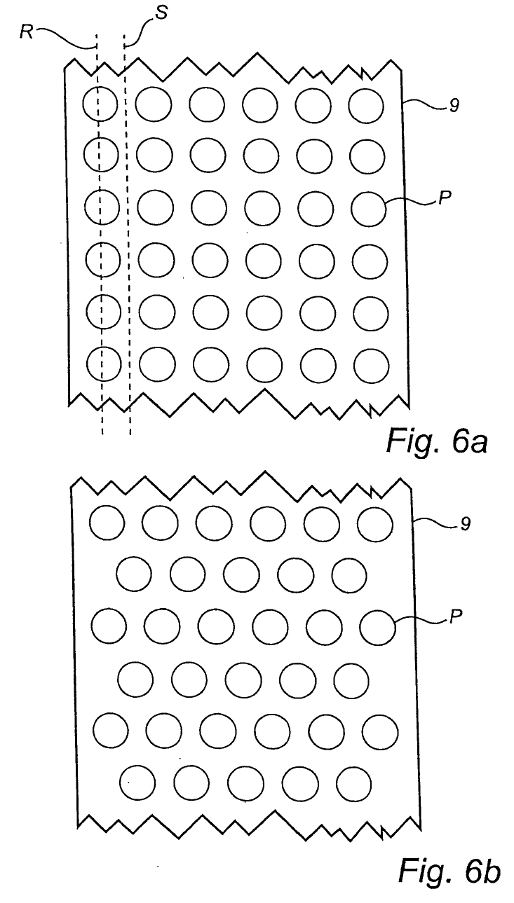

In the embodiments shown in FIGS. 3-5, the conveyor belt 9 is perforated, thus presenting a plurality of substantially circular holes P, all of which having a diameter that is smaller than the smallest coin, which is to be processed by the coin processing apparatus 1. In the embodiment of FIG. 3, the holes are arranged in straight rows R (FIGS. 6a-6b) both along the conveyor belt 9 and across the conveyor belt 9. Thus, between each longitudinal row of holes, there is an un-perforated strip of belt material. The discs of the pulleys may be arranged so as to match the un-perforated strips S of belt material between the rows R.

In the embodiments of FIGS. 3 and 4, the second pulley 8 is arranged at a higher vertical level than the first pulley 7, thereby causing the conveyor belt 9 which is arranged around the pulleys 7, 8 to be inclined. Thus, items transported on the conveyor belt 9 will be moving upward in the conveyor belt's principal direction of movement DF.

Between the upper and lower portions 9a, 9b of the conveyor belt 9, the removable dust collection tray 18 is arranged. The dust collection tray 18 may be arranged like a drawer. The tray 18 may further be arranged so as to cover a large part of the area under the perforated belt 9 between the pulleys 7, 8, so as to be able to collect any non-coin matter that falls through the perforations of the upper portion 9a of the belt 9. The dust collection tray 18 may have a handle 19 for facilitating its removal from the frame 5.

A drive unit 12 may be connected to one (or both) of the pulleys 7, 8. In the embodiments of FIGS. 3 and 4, the drive unit 12 is connected to the first pulley 7. The drive unit 12 may be an actuator, such as an electrical motor. However the drive unit 12 does not necessarily need to be a separate motor, but may be connected to a second drive unit that is housed within the coin processing apparatus 1, such as e.g. the motor driving the coin lifting device 4. Other arrangements are also possible for the drive unit 12.

Furthermore, a rotation sensor 13 may be provided at one, or both, of the pulleys 7, 8, for providing an indication that the pulleys 7, 8 are rotating, and thus working properly. In one embodiment, the rotation sensor 13 may comprise a sensor which receives a predetermined number (e.g. 1) of pulses during each rotation of a pulley. The pulses may be provided to the control equipment (not shown). In case a pulley ceases to rotate, e.g. due to an object which prevents it from rotating, the pulses will cease, which the control equipment may interpret as an error condition, whereby appropriate measures may be taken. For example, the control equipment may provide a signal to the user, indicating that the error has occurred. In one embodiment, the drive unit 12 may be reversed in response to a stoppage of a pulley 7; 8 being detected, thus enabling an object that is obstructing the pulleys to fall through the perforations. A combination of signaling and reversing the conveyor belt is also conceivable.

In the embodiments of FIGS. 3-5, an agitator 14 has been arranged between the pulleys 7, 8 and between the upper 9a and lower 9b portions of the belt 9. The agitator may be arranged to cause the upper portion 9a of the conveyor belt 9 to agitate, i.e. to vibrate or shake in e.g. a direction orthogonal to the conveyor belt's principal direction of movement DF. The agitator 14 used in the embodiment of FIG. 3 comprises a number of protruding parts. As seen in FIG. 10, the protruding parts of the agitator 14 may be a number of relatively small ball bearings 20a (i.e. having a diameter smaller than that of the pulleys 7, 8, but larger than that of the perforations P), which are arranged on a common axis 23c that extends between the side walls 15a, 15b. An advantage with using ball bearings for the protruding parts of the agitator 14 is that they reduce the friction between the protruding part and the belt 9. The ball bearings 20a are aligned with the longitudinal rows R of perforations P, such that when the conveyor belt 9 is moving, the ball bearings 20a will alternately force the belt 9 upwards to an upper position (indicated as P1 for the second embodiment of FIG. 5) and alternately allow the belt to drop to a lower position (indicated as P2 for the second embodiment of FIG. 5), which may be equal to the belt's normal position (indicated as P0 for the second embodiment of FIG. 5), i.e. a position which is on a substantially straight line between the uppermost parts of the pulley perimeters. Thus, P0 is the normal position for any conveyor belt that is arranged between two pulleys. The effect of this type of agitator may be improved in case the conveyor belt is slightly flexible.

The agitator 14 may be arranged so as to cause the lower position P2 of the belt to differ from the normal position P0. Thus, the upper portion 9a of the belt may be caused to present two sections 22a, 22b having different inclination. As is shown in FIG. 3, a first section 22a may have a steeper inclination than a second section 22b. This arrangement may be advantageous when it is desirable to, given a limited space, provide a belt with a strong enough inclination for reducing the amount of coins that are piled on top of each other when conveyed towards the output end 11 of the conveyor belt 9. Thus the section 22a having strong inclination operates so as to reduce the amount of piled coins, while the section 22b having weaker inclination allows non-coin matter to be separated from the coins.

FIGS. 4 and 5 show a slightly different embodiment of the coin conditioning device 2. In the embodiment of FIGS. 4 and 5, the entire conveyor belt 9 is inclined, so that the belt does not need to be divided into two sections 22a and 22b as shown in FIG. 3. Furthermore, the agitator 14 of FIGS. 4 and 5 is constituted by a single protruding part 20, for instance one of the ball bearings 20a in FIG. 10, as will be described further below.

At an output end 11 of the conveyor belt 9, the plurality of coins may be allowed to drop freely down into the hopper or coin lifting device 4. In the embodiment described in FIG. 3, there is a dust collection plate 16 arranged under the second pulley 8 and extending at least so far towards the first pulley 7, so as to protect the hopper or coin lifting device 4 from any material which may stick to the conveyor belt after having passed the second pulley 8. The dust collection plate 16 may be arranged as a tray, having edges or a container for retaining objects collected by it.

FIGS. 6a and 6b illustrate different configurations of conveyor perforations. In the embodiment described above, which is shown in FIG. 6a, the perforations were arranged in straight rows R, both along and across the conveyor belt 9, leaving a strip S of in perforated belt material between each row R. This configuration is advantageous for combination with the disc-shaped pulleys described above. As an alternative, the amount of perforations in a configuration could be maximized, by arranging the perforations as is shown by way of example in FIG. 6b, which may be desirable for maximizing the conditioning effect. Other configurations of perforations, especially other shapes of the perforations themselves, are possible.

In one embodiment of the invention, the belt may be fabricated from a glass fiber reinforced rubber material. Other materials are also conceivable, such as polymer materials, and other types of reinforcement (e.g. Kevlar, carbon fiber etc). Even thin sheet metal or fabrics may be used. Different combinations of pulleys and belt materials are conceivable.

The surface of the conveyor belt may be provided with means for increasing friction, in order to bring those coins that are closest to the belt to move faster than those coins that are situated on top. Essentially, the aim is to provide the conveyor belt 9 with a surface that causes the friction between the belt 9 and a coin transported thereon to be higher than the friction between two coins that are piled on top of each other.

Such means for increasing the friction may comprise providing the surface of the belt with a friction increasing material, such as e.g. rubber, elastomers or lightly adhesive materials. The friction increasing material may be disposed over the entire surface of the belt (excluding, of course, the perforations), or only in partial areas thereof. For example, the material may be disposed in the form of projecting dots, forming inverted dimples in the surface, or in the form of projecting grooves. Such projections may also be provided in a surface which is otherwise entirely coated with the friction increasing material. Thus, the surface structure may be modified, such as made rough etc.

It is also conceivable to provide the belt surface with a surface structure that increases the friction between the belt surface and coins transported on the belt. Examples of such pattern may be grooves, protrusions or projecting dots.

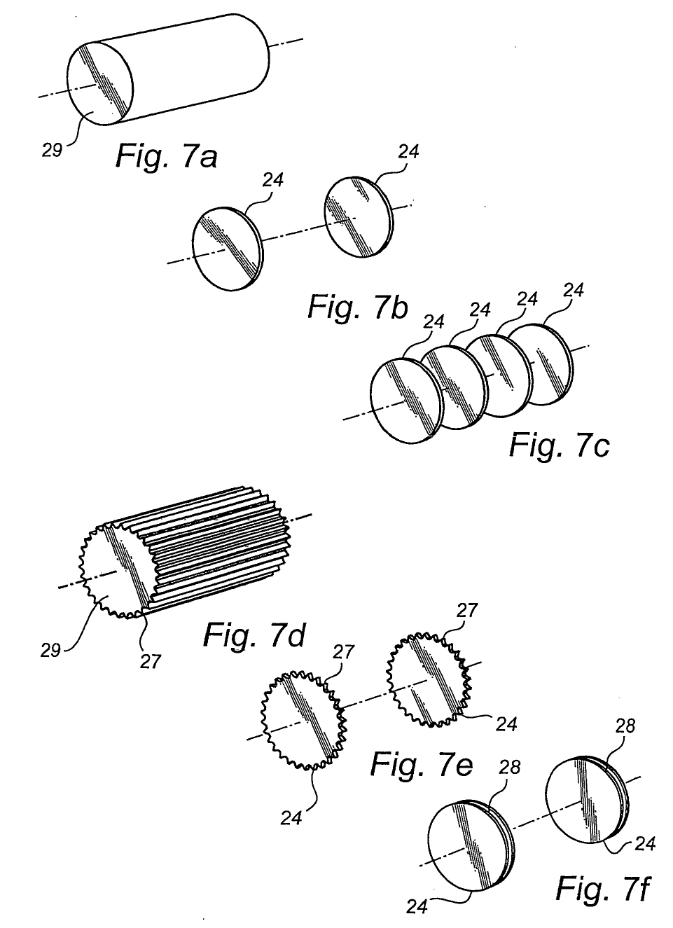

FIGS. 7a-7f illustrate examples of different pulley designs. The pulleys may be designed in a multitude of ways. For example, as is illustrated in FIG. 7a, a pulley 7, 8 may be designed as a cylindrical drum 29, which is rotatable around an axis 23, and around which the conveyor belt 9 may be disposed.

In an alternative embodiment, as is shown in FIGS. 7b and 7c, the pulley may comprise a number of discs 24 that are arranged on a common axis 23 (or which are made in one piece with the axis as is shown in FIG. 10). In the embodiment described above, where the perforations P of the conveyor belt 9 are linearly arranged in rows in the belt's principal direction of movement DF, the discs 24 may be arranged so that the contact surface between the disc 24 and the belt 9 is at the surface of the belt 9, between two such linearly arranged rows R of perforations P, such that the discs 24 will be in constant contact with the surface of the belt 9. This may be advantageous, since it allows long objects to protrude through the belt at the pulley, thereby decreasing the risk of such long objects obstructing the operation of the pulley 7, 8.

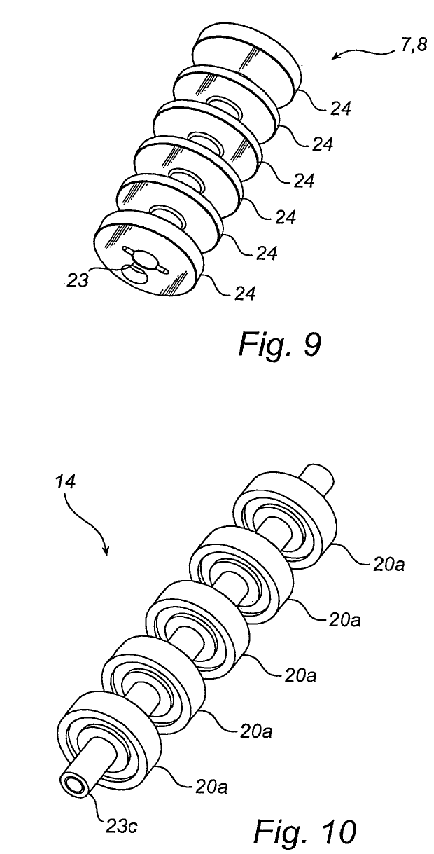

In order to prevent the belt from collapsing in the case where the pulleys are made up by discs 24, each pulley 7, 8 may comprise several discs 24, as shown in FIG. 7c. For example, the number of discs 24 may be adapted to the type of conveyor belt used; such that there is one disc 24 at each edge of the belt 24 and one disc between each two rows of linearly arranged perforations, as is illustrated in FIGS. 7c and 9. Thus, each disc 24 may be aligned with a strip S of un-perforated material.

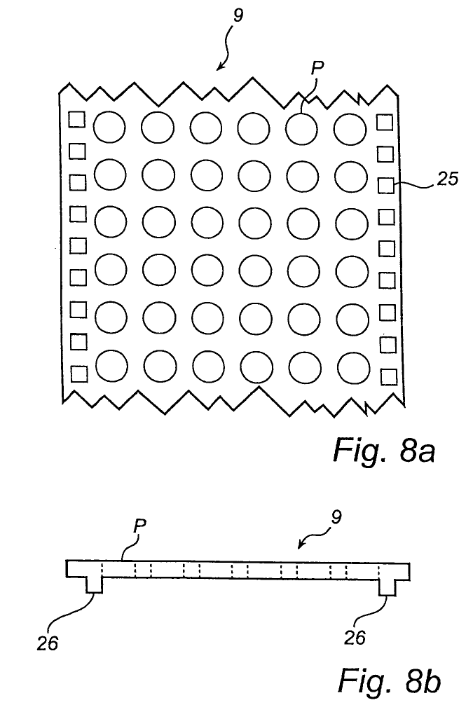

In an embodiment where only two discs 24 (such as in FIG. 7b, 7e or 7f) are chosen, there are alternative ways of preventing the belt from collapsing. One such way is to restrain the belt's movement in the direction of the pulleys' rotational axes 23. A first way of doing this is shown in FIG. 7f. Here, a groove 26 is arranged on the backside of the belt (see FIG. 8b), the groove 26 being matched to a corresponding groove 28 (FIG. 8b) on the perimeter of the disc 24. Another alternative is illustrated in FIG. 7e, i.e. to provide drive perforations 25 along the edges of the belt 9 (see FIG. 8a), which drive perforations 25 are matched with teeth 27 on the perimeter of the pulley 7, 8, such as is the case with e.g. 35 mm photographic film.

Furthermore, the pulleys and/or the conveyor belt may be arranged so as to increase the friction between the conveyor belt and the pulleys. Thus, the backside of the belt and/or the perimeter of the pulley may be provided with e.g. a friction increasing material or surface structure.

Also, in the case where the pulleys are embodied as drums 29, a surface pattern may be provided on the perimeter of the drum 29, which surface pattern matches the pattern of the perforations of the conveyor belt 9. In an extreme case, as is shown in FIG. 7d, teeth 27 may be arranged throughout the length of a cylindrical drum, such as to cause it to act as a large gearwheel.

Also the agitator 14 may be subject to a vast amount of variations. In the embodiment described with reference to FIGS. 4 and 5, a single protruding part 20 may be placed at one of the rows R of perforations P, thus causing the conveyor belt to be lifted in a “pyramid” fashion, i.e. when at position P1, the conveyor belt will have an inclination not only towards the first and second pulleys 7,8, but also towards the side walls 15a, 15b.

As another alternative, a rotating cam wheel (not shown) may be arranged at the conveyor belt. The cam wheel may be driven by its own drive unit, or by the drive unit 12 of the conditioning device 2. When the cam wheel is rotated, it may cause the belt to agitate with a predetermined amplitude and frequency.

Yet another alternative is to provide a device, such as a piston, which is caused to strike against the conveyor belt 9 at a predetermined frequency.

Another solution may be to provide one or both pulleys 7, 8 with a cam wheel form, or any other “irregular” form, so that the conveyor is caused to agitate as a result of the rotation of the pulley(s). In the case where both pulleys 7, 8 have cam wheel form, these may be arranged so as to rotate in or out of phase.

A further alternative may comprise using a step motor for driving the conveyor belt. Alternatively, the drive unit 12 could be intermittently driven, e.g. alternately forwards and backwards, so as to cause the belt 9 to agitate in the movement direction as well.

As yet another option, a height limiter (not shown) may be included, with the purpose of further limiting the amount of piled coins that may be conveyed on the belt 9. A height limiter may take the shape of e.g. a plate, a rake or a beam, which is arranged at a suitable height above the surface of the conveyor belt 9.

Another option may be a coin tipping device (not shown) for preventing coins from remaining or traveling standing up along the side walls 15a, 15b of the conditioning device 2. Such a device may comprise a protrusion which is arranged at an appropriate height on the side walls 15a, 15b.

Finally, it is possible to arrange a brush or a scrape (not shown) for cleaning the belt, after the coins have been discharged at the output end 11.

While the invention has been described in terms of an exemplifying embodiment, followed by some currently contemplated design variations, it is realized that a number of different embodiments may be achieved, through combination of the different design variations described, without departing from the scope of the appended claims.

1. A coin conditioning device for separating non-coin matter from a plurality of coins, characterized by
a belt conveyor having a perforated conveyor belt, and
a belt agitator, which is arranged for agitating the conveyor belt while said plurality of coins and said non-coin matter are being conveyed on said conveyor belt.

2. The coin conditioning device as claimed in claim 1, said conveyor belt including a section that is upwardly inclined in said conveyor belt's principal direction of movement.

3. The coin conditioning device as claimed in claim 1, said conveyor belt including an upper section, said an upper portion of said conveyor belt presenting
a first section having a first inclination upwards in said conveyor belt's principal direction of movement, and
a second section having a second inclination upwards in said principal direction of movement,
wherein said first inclination is steeper than said second inclination.

4. The coin conditioning device as claimed in claim 2, said perforated conveyor belt including a row of perforations, which is arranged in parallel with said principal direction of movement.

5. The coin conditioning device as claimed in claim 4, said belt agitator comprising a protruding part which is arranged to interact with said row of perforations, such that said conveyor belt is in an upper position when said protruding part is between two of said perforations in said row, and said belt is in a lower position when said protruding part at least partly enters one of said perforations.

6. The coin conditioning device as claimed in claim 5, said protruding part comprising a ball bearing, which is fixedly mounted relative to a side wall of said coin conditioning device.

7. The coin conditioning device as claimed in claim 5, said protruding part comprising a plurality of ball bearings, all of which are arranged on a common axis, and each of which is arranged to interact with a respective row of perforations.

8. The coin conditioning device as claimed in claim 1, said perforated conveyor belt defining a load supporting surface, said load supporting surface of said perforated conveyor belt being at least partly provided with means for enhancing its friction properties.

9. The coin conditioning device as claimed in claim 1, further comprising first and second pulleys for supporting said perforated conveyor belt, whereby at least one of said first and second pulleys comprises at least two discs which are arranged to rotate around a common rotational axis.

10. The coin conditioning device as claimed in claim 9, at least one of said discs being aligned with an un-perforated strip of said conveyor belt.

11. The coin conditioning device as claimed in claim 3, further including a dust collection tray for collecting the non-coin matter falling through said perforations of said conveyor belt, said dust collection tray being arranged between said upper portion of said conveyor belt, which moves in said principal direction, and a lower portion of said conveyor belt, which moves in a direction opposite to said principal direction.

12. A coin processing apparatus for processing a plurality of coins, comprising:
a coin conditioning device including a belt conveyor having a perforated conveyor belt and a belt agitator, which is arranged for agitating said conveyor belt while said plurality of coins and said non-coin matter are being conveyed on said conveyor belt.

13. The coin processing apparatus as claimed in claim 12, and said coin conditioning device being positioned in said coin processing apparatus so as to receive, at a input end, said plurality of coins from a coin input device and to supply, at an output end, said plurality of coins to one of a coin discriminating device, a coin counting device, a coin sorting device and a coin verification device.

14. The coin processing apparatus as claimed in claim 13, and said coin input device comprising an input tray.

15. A method for conditioning a plurality of coins by separating non-coin matter from the plurality of coins, comprising conveying the plurality of coins, including said non-coin matter, on a belt conveyor having a perforated conveyor belt, while causing the conveyor belt to agitate, so as to cause at least some of the non-coin matter to fall through the perforated belt.

16. The method as claimed in claim 15, wherein conveying the plurality of coins comprises conveying the plurality of coins on a perforated conveyor belt, which is upwardly inclined in its principal direction of movement.
